(19) United States
(12) Patent Application Publication
(10) Pub. No.: US 2024/0383544 A1
(43) Pub. Date: Nov. 21, 2024

(54) AERODYNAMIC CARGO TRANSPORT

(71) Applicant: STI Holdings, Inc., Stoughton, WI (US)

(72) Inventors: Denys Bykovskyi, Madison, WI (US); Gary Lynn Fenton, Edgerton, WI (US); Matthew Simon Kinsman, Fort Atkinson, WI (US)

(21) Appl. No.: 18/667,849

(22) Filed: May 17, 2024

Related U.S. Application Data
(60) Provisional application No. 63/503,316, filed on May 19, 2023.

(51) Int. Cl. B62D 35/00; B62D 33/04

(52) U.S. Cl. CPC B62D 35/001; B62D 33/04

(57) ABSTRACT

A cargo transport includes a chassis, a plurality of wheels configured to support the chassis, a cargo box supported by the chassis, and a rear frame coupled to a rear end of the cargo box. The rear frame includes a header, a rear bolster disposed below the header, and a pair of opposed vertical frame members extending between the rear bolster and the header. The header is positioned at least partially above a roof of the cargo box and includes a plurality of openings configured to induce turbulence within airflow at the rear end of the cargo box.

### CROSS-REFERENCE TO RELATED APPLICATIONS

This application claims priority to U.S. Provisional Patent Application No. 63/503,316, filed on May 19, 2023, the entire contents of which are incorporated herein by reference.

### BACKGROUND

The invention relates to over-the-road cargo transports, for example over-the road trailers or straight trucks. More particularly, the invention relates to such cargo transports with structures to increase aerodynamic efficiency during highway transport.

### SUMMARY

In one aspect, the disclosure provides a cargo transport including a chassis, a plurality of wheels configured to support the chassis, a cargo box supported by the chassis, and a rear frame coupled to a rear end of the cargo box. The rear frame includes a header, a rear bolster disposed below the header, and a pair of opposed vertical frame members extending between the rear bolster and the header. The header is positioned at least partially above a roof of the cargo box and includes a plurality of openings configured to induce turbulence within airflow at the rear end of the cargo box.

In another aspect, the disclosure provides a cargo transport including a chassis, a plurality of wheels configured to support the chassis, a cargo box supported by the chassis, and a rear frame coupled to a rear end of the cargo box. The rear frame includes a header including a forward plate and a rearward plate, a rear bolster disposed below the header, and a pair of opposed vertical frame members extending between the rear bolster and the header. The rearward plate is disposed rearward of the rear end of the cargo box and includes a plurality of openings extending therethrough, and the plurality of openings are configured as a duct to charge airflow therethrough and counteract a negative-pressure air pocket rearward of the cargo box.

In yet another aspect, the disclosure provides a cargo transport including a chassis, a plurality of wheels configured to support the chassis, a cargo box supported by the chassis, and a rear frame coupled to a rear end of the cargo box. The rear frame includes a header, a rear bolster disposed below the header, and a pair of opposed vertical frame members extending between the rear bolster and the header. The header includes a plurality of triangular openings configured to induce turbulence within airflow at the rear end of the cargo transport.

### BRIEF DESCRIPTION OF THE DRAWINGS

FIG. 1 is rear perspective view of a trailer according to one embodiment of the present disclosure.

FIG. 2 is a rear view of the trailer of FIG. 1.

FIG. 3 is a perspective view of an upper portion of a rear of the trailer of FIG. 1, illustrating a rear frame header.

FIG. 4 is a side view of the rear frame header.

FIG. 5 is a close-up perspective view of a portion of the rear frame header.

### DETAILED DESCRIPTION

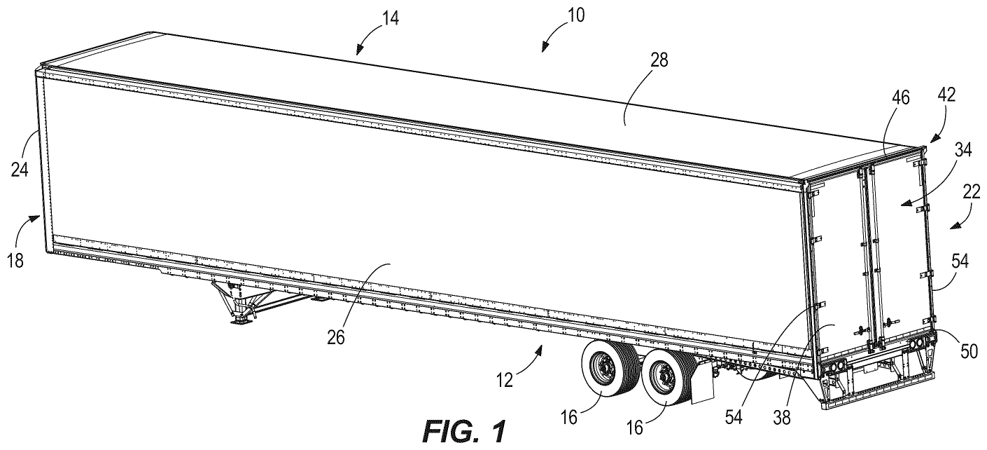

FIG. 1 illustrates a trailer 10, such as an enclosed over-the-road commercial transport semi-trailer or “dry van,” although the trailer may take a variety of other configurations. In yet other constructions, aspects of the present disclosure may be incorporated in another type of cargo transport such as a straight truck including a cargo box fixed relative to a cab. The trailer 10 includes a chassis 12 supporting a cargo box 14 defined between a front or leading end 18 and a rear or trailing end 22. The chassis 12 supports the cargo box 14 above a road surface in part by a plurality of wheels 16. Although in some embodiments the chassis 12 can extend a full length of the trailer 10 or a majority thereof, “chassis” may also refer to the structure immediately surrounding and supporting the set of wheels 16. The chassis 12 and the cargo box 14 can be removably attachable. The cargo box 14 includes a front wall 24, a plurality of side walls 26 and a roof 28 that define an interior space which contains cargo when the trailer 10 is in use. An opening 34 is positioned at the rear end 22 to allow for loading and unloading of cargo, and at least one door 38 is coupled to the opening 34 to selectively close the opening 34 (e.g., a pair of swingable doors as shown, or a roll-up door). As will be understood by one of ordinary skill in the art, increasing fuel efficiency decreases operating costs of the trailer 10. Increasing fuel efficiency can be accomplished in many ways. For example, improving the aerodynamic efficiency of the trailer 10 (e.g., reducing aerodynamic drag) is one method for increasing fuel efficiency. One way to decrease drag is to decrease negative air pressure at the trailing end 22.

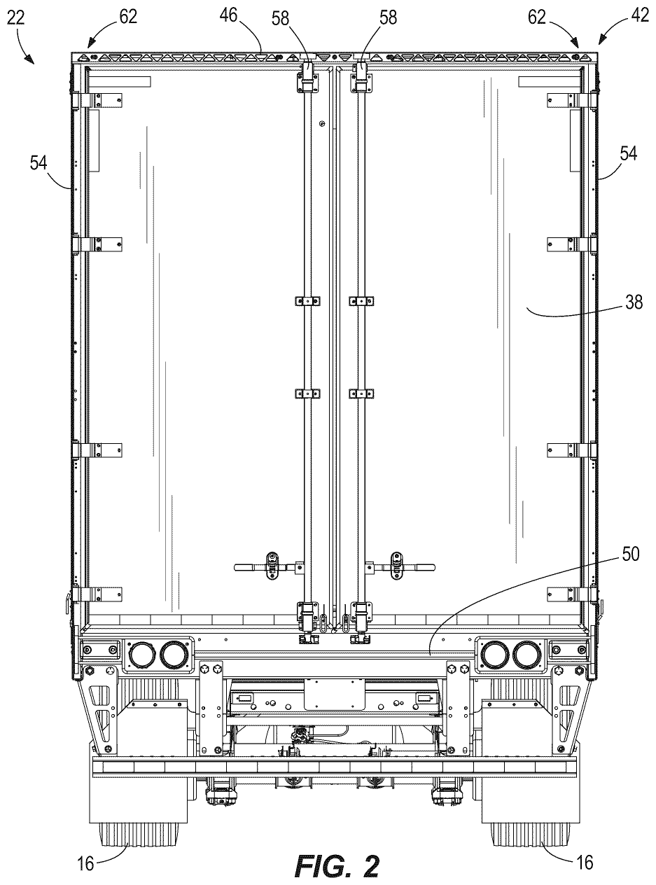

With reference to FIGS. 1 and 2, the trailing end 22 of the trailer 10 includes a rear frame 42 surrounding the opening 34. The rear frame 42 includes a header 46 positioned above the opening 34, a rear bolster 50 positioned below the opening 34, and a pair of opposed vertical frame members 54 positioned on opposite sides of the opening 34 and extending between the header 46 and the rear bolster 50. The rear frame 42 is formed of sheet metal parts that are welded or fastened together. In other constructions, the header 46 may be formed of extruded aluminum or other materials. The rear frame 42 is configured to protect the rear end 22 of the trailer 10 and support other features of the trailer 10. For example, the header 46 may support upper lock rod keepers 58 and/or lights 62 (e.g., position lights).

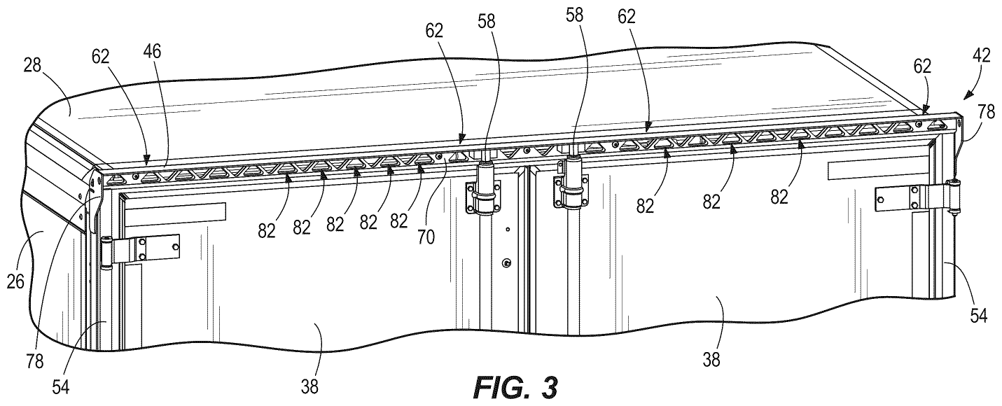

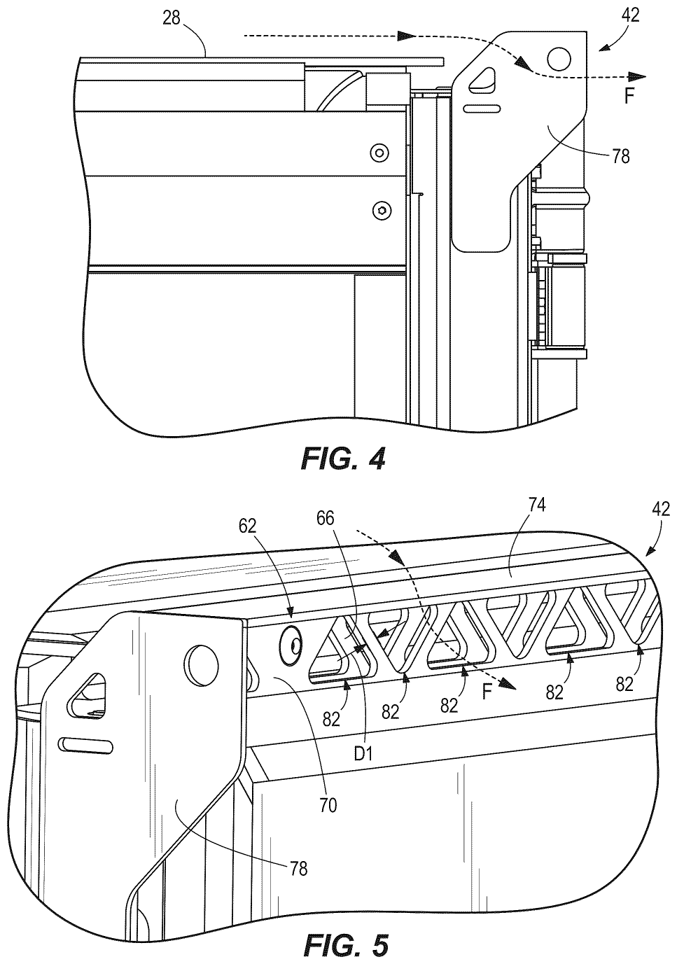

With reference to FIGS. 3-5, the header 46 extends above the roof 28 of the trailer 10 to improve airflow at the rear end 22 of the trailer 10. In other words, when viewed from the side (FIG. 4), the header 46 extends above the roof 28 of the trailer 10 and rearward of the trailer. The header 46 includes a forward plate 66, a rearward plate 70 spaced apart from the forward plate 66, and an upper plate 74 coupling the forward plate 66 to the rearward plate 70. Both of the forward and rearward plates 66, 70 are vertically oriented, and the upper plate 74 is horizontally oriented. Each of the forward and rearward plates 66, 70 spans a width of the header 46 (e.g., extends between the opposed vertical frame members 54). The header 46 further includes a pair of brackets 78 coupled to the forward, rearward, and upper plates 66, 70, 74. The brackets 78 couple the header 46 to the opposed vertical frame members 54 of the rear frame 42. The brackets 78 couple the forward, rearward, and upper plates 66, 70, 74 to the opposed vertical frame members 54 and position the header 46 rearward of and above the roof 28. Referring to FIGS. 3 and 5, the forward and rearward plates 66, 70 each include a plurality of openings 82. The openings 82 of the forward and rearward plates 66, 70 are aligned within one another to allow airflow through the header 46. In some embodiments, the openings 82 in the forward and rearward plates 66, 70 may be misaligned. In the illustrated embodiment, the openings 82 are triangular in shape. Adjacent openings 82 have an opposite orientation or are rotated by 180 degrees relative to one another such that the triangular-shaped openings are nested to increase the number of openings 82. Adjacent openings 82 are spaced apart and may partially overlap in a vertical direction. In other constructions, the openings 82 may have other shapes and/or the openings 82 may take multiple/various shapes. Furthermore, in the illustrated embodiment, the number of openings 82 is maximized while maintaining sufficient space on the header 46 (e.g., on the rearward plate 70) to support the lights 62 and the lock rod keepers 58. Thus, the openings 82 form a repeating pattern of triangles, each rotated by 180 degrees and spaced along the header 46. A gap or interruption in the repeating pattern (i.e., a larger space between adjacent openings 82) defines a space for mounting of the upper lock rod keepers 58 and/or lights 62. As viewed from the front and/or the rear, the area of the openings 82 may be a majority of the overall exposed area of the header 46. For example, the area of the openings 82 may be greater than 70% of the overall exposed area of the header 46 or may be greater than 85% of the overall exposed area of the header 46. In some constructions, the area of the openings 82 can be expanded such that there is no practicable location for mounting any of the lights 62 (which may be relocated lower on the rear frame 42). In some constructions, there are at least 30 or at least 40 distinct passages (e.g., pairs of openings 82 in the forward and rearward plates 66, 70) for air to flow through the header 46.

The header 46 may be formed of 8-gauge steel having a thickness of approximately 0.16 inches. The forward and rearward plates 66, 70 are oriented parallel to one another and spaced apart in a direction of travel of the trailer 10 by approximately 0.4 inches. The plurality of openings 82 are spaced apart along the forward and rearward plates 66, 70 (e.g., along a width of the trailer 10) by approximately 0.3 inches of material as measured in a direction DI perpendicular to adjacent legs of the triangle.

In operation, the header 46 extends above the roof 28 of the trailer 10 to improve airflow from the rear end 22 of the trailer 10. An airflow path F is defined along the roof 28, through the header 46, and the rear end 22 of the trailer 10. The openings 82 of the header 46 are oriented perpendicular to a direction of travel of the trailer 10 and may function as a duct to charge the airflow F from the rear end 22 of the trailer 10 to decrease a size of a trailing negative air pocket that may form directly rearward of the trailer 10. Decreasing the size of the negative air pocket increases fuel efficiency when towing the trailer. The numerous edges defining the openings 82 may further function to induce turbulence as the airflow F passes over the rear end 22 of the trailer 10. In other words, the openings 82 function as vortex generators to induce or increase an amount of turbulence within the airflow F. Turbulence within the airflow can cause a fluid boundary layer to remain attached further around the rear end 22, and thus decreases the size of the trailing negative air pocket, with the effect of decreasing drag on the trailer.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention. For example, one having ordinary skill in the art will appreciate that specific features of the numerous embodiments disclosed may be mixed and matched in other ways where not specifically inhibited, even though specific illustration of such embodiments may not be exhaustively covered herein.

What is claimed is:

1. A cargo transport comprising:
a chassis;
a plurality of wheels configured to support the chassis;
a cargo box supported by the chassis; and
a rear frame coupled to a rear end of the cargo box, the rear frame including:
a header,
a rear bolster disposed below the header, and
a pair of opposed vertical frame members extending between the rear bolster and the header,
wherein the header is positioned at least partially above a roof of the cargo box and includes a plurality of openings configured to induce turbulence within airflow at the rear end of the cargo transport.

2. The cargo transport of claim 1, wherein the header includes a forward plate and a rearward plate, and wherein the plurality of openings is disposed within each of the forward plate and the rearward plate.

3. The cargo transport of claim 2, wherein the plurality of openings of the forward plate and the plurality of openings of the rearward plate are aligned.

4. The cargo transport of claim 1, wherein the header extends a width of the cargo box, and wherein the plurality of openings are spaced along the header.

5. The cargo transport of claim 1, wherein each the plurality of openings is triangular in shape.

6. The cargo transport of claim 5, wherein adjacent openings are rotated by 180 degrees relative to one another.

7. The cargo transport of claim 6, wherein the plurality of openings forms a repeating pattern of openings rotated by 180 degrees relative to one another, and wherein the repeating pattern is interrupted to couple a light to the header.

8. A cargo transport comprising:
a chassis;
a plurality of wheels configured to support the chassis;
a cargo box supported by the chassis; and
a rear frame coupled to a rear end of the cargo box, the rear frame including:
a header including a forward plate and a rearward plate,
a rear bolster disposed below the header, and
a pair of opposed vertical frame members extending between the rear bolster and the header,
wherein the rearward plate is disposed rearward of the rear end of the cargo box and includes a plurality of openings extending therethrough, and
wherein the plurality of openings are configured as a duct to charge airflow and counteract a negative-pressure air pocket rearward of the cargo box.

9. The cargo transport of claim 8, wherein the forward plate includes a plurality of openings extending therethrough.

10. The cargo transport of claim 9, wherein the plurality of openings of the forward plate are aligned with the plurality of openings of the rearward plate.

11. The cargo transport of claim 10, wherein the plurality of openings of the forward plate and the plate and the plurality of openings of the rearward plate have a similar shape.

12. The cargo transport of claim 8, wherein each of the plurality of openings is triangular in shape.

13. The cargo transport of claim 12, wherein adjacent openings of the plurality of openings are rotated by 180 degrees relative to one another.

14. The cargo transport of claim 13, wherein adjacent openings of the plurality of openings overlap vertically.

15. A cargo transport comprising:
a chassis;
a plurality of wheels configured to support the chassis;
a cargo box supported by the chassis; and
a rear frame coupled to a rear end of the cargo box, the rear frame including:
a header,
a rear bolster disposed below the header, and
a pair of opposed vertical frame members extending between the rear bolster and the header,
wherein the header includes a plurality of triangular openings configured to induce turbulence within airflow at the rear end of the cargo transport.

16. The cargo transport of claim 15, wherein the header includes a forward plate and a rearward plate spaced apart from the forward plate, and wherein the plurality of triangular openings extend through both the forward plate and the rearward plate.

17. The cargo transport of claim 15, wherein adjacent openings of the plurality of openings are rotated by 180 degrees relative to one another.

18. The cargo transport of claim 17, wherein adjacent openings of the plurality of openings at least partially overlap vertically.

19. The cargo transport of claim 15, wherein the plurality of openings includes at least 30 openings.

20. The cargo transport of claim 19, wherein the plurality of openings includes at least 40 openings.
